(19) United States
(12) Patent Application Publication
(10) Pub. No.: US 2026/0036788 A1
(43) Pub. Date: Feb. 5, 2026

(54) OPTICAL SYSTEM

(71) Applicant: ZHEJIANG SUNNY OPTICS CO., LTD., Yuyao City (CN)

(72) Inventors: Huan LIU, Yuyao City (CN); Xiaobin ZHANG, Yuyao City (CN); Lin HUANG, Yuyao City (CN); Yinfang JIN, Yuyao City (CN); Liefeng ZHAO, Yuyao City (CN)

(73) Assignee: ZHEJIANG SUNNY OPTICS CO., LTD., Yuyao City (CN)

(21) Appl. No.: 19/271,214

(22) Filed: Jul. 16, 2025

(30) Foreign Application Priority Data
Aug. 2, 2024 (CN) 202411057219.5

(51) Int. Cl. G02B 13/00; G02B 5/30; G02B 9/34

(52) U.S. Cl. CPC G02B 13/004; G02B 5/3083; G02B 9/34

(57) ABSTRACT

Disclosed is an optical system, sequentially including along the optical axis from a first side to a second side: a first lens having positive refractive power, its first side surface being convex and its second side surface being planar; a reflective polarizing element; a first quarter-wave plate; a second lens having positive refractive power, its first side surface being convex; a third lens having negative refractive power, its first side surface being concave and its second side surface being planar; a partially reflective element; a second quarter-wave plate; a polarizer; and a fourth lens having negative refractive power; wherein the number of lenses with refractive power in the optical system is four; the effective focal length f1 of the first lens and the effective focal length f3 of the third lens satisfy: −1.5<f3/f1<−1.0; and it is satisfied:

$$2 \leq ( CT 3 + CTQ 2 + CTL ) / ( CT 1 + CTR + CTQ 1 ) < 2.9 .$$

### CROSS-REFERENCE TO RELATED APPLICATIONS

The present application claims priority to and benefit of China patent application No. 202411057219.5, filed on Aug. 2, 2024, which is hereby incorporated by reference in its entirety.

### TECHNICAL FIELD

The present application relates to the field of optical elements, and more specifically, to an optical system comprising a four-lens structure.

### BACKGROUND

In recent years, with the emergence of the “metaverse” concept, human-computer interaction-enhanced Augmented Reality (AR) and Virtual Reality (VR) have ushered in a second opportunity for development. Among them, head-mounted devices for AR/VR equipment can make users feel as if they are in different environments, bringing tremendous changes in fields such as social interaction, entertainment, medical care, and education.

Catadioptric optical systems can compress the optical path through the characteristics of polarized light, and also have the functions and advantages of providing a larger field of view and reducing glare and scattering, and are often used in optical system solutions for AR/VR equipment. A catadioptric optical system is a complex system composed of multiple lenses and optical elements, used to control and manipulate the propagation and imaging of light. When designing and optimizing optical systems, many factors need to be considered, such as aberrations, resolution, focusing capability, light transmittance, etc.

However, current optical systems suitable for head-mounted devices of AR/VR equipment often suffer from at least one problem such as low imaging clarity, poor image stability, or insufficient system compactness.

### SUMMARY

According to embodiments of the present application, an optical system is provided, which sequentially comprises along the optical axis from a first side to a second side: a first lens with positive refractive power, having a convex first side surface and a planar second side surface; a reflective polarizing element; a first quarter-wave plate; a second lens with positive refractive power, having a convex first side surface; a third lens with negative refractive power, having a concave first side surface and a planar second side surface; a partially reflective element; a second quarter-wave plate; a polarizer; and a fourth lens with negative refractive power; wherein the number of lenses with refractive power in the optical system is four, and the effective focal length f1 of the first lens and the effective focal length f3 of the third lens satisfy: −1.5<f3/f1<−1.0; and the center thickness CT3 of the third lens on the optical axis, the center thickness CTL of the polarizer on the optical axis, the center thickness CTQ2 of the second quarter-wave plate on the optical axis, the center thickness CT1 of the first lens on the optical axis, the center thickness CTR of the reflective polarizing element on the optical axis, and the center thickness CTQ1 of the first quarter-wave plate on the optical axis satisfy:

$$2 \leq ( CT 3 + CTQ 2 + CTL ) / ( CT 1 + CTR + CTQ 1 ) < 2.9 .$$

In some embodiments, the effective focal length f2 of the second lens and the radius of curvature R3 of the first side surface of the second lens satisfy: 1≤f2/R3<1.8.

In some embodiments, the distance TD on the optical axis from the first side surface of the first lens to the second side surface of the fourth lens and the effective focal length f of the optical system satisfy: 0.5<TD/f<0.6.

In some embodiments, the effective focal length f4 of the fourth lens and the effective focal length f of the optical system satisfy: −1.4<f4/f≤−0.7.

In some embodiments, the refractive index N3 of the third lens, the refractive index N1 of the first lens, the Abbe number V3 of the third lens, and the Abbe number V1 of the first lens satisfy:

$$1. < N 3 / N 1 < 1.2 ; 0.4 < V 3 / V 1 < 0.7 .$$

In some embodiments, the effective focal length f of the optical system, the center thickness CT1 of the first lens on the optical axis, the center thickness CTR of the reflective polarizing element on the optical axis, and the center thickness CTQ1 of the first quarter-wave plate on the optical axis satisfy: 11<f/(CT1+CTR+CTQ1)<12.4.

In some embodiments, the effective focal length f1 of the first lens and the radius of curvature R1 of the first side surface of the first lens satisfy: 1.3<f1/R1<2.1.

In some embodiments, the center thickness CT3 of the third lens on the optical axis, and the sum of the center thicknesses of the first lens to the fourth lens on the optical axis ΣCT satisfy:

$$0.35 < CT 3 / \sum CT < 0.55 .$$

In some embodiments, the entrance pupil diameter EPD of the optical system and the distance TD on the optical axis from the first side surface of the first lens to the second side surface of the fourth lens satisfy: 0.9<EPD/TD<1.0.

In some embodiments, the effective focal length f3 of the third lens and the radius of curvature R5 of the first side surface of the third lens satisfy: 1.3<f3/R5<1.5.

In some embodiments, the combined focal length FG1 of the first lens and the reflective polarizing element and the first quarter-wave plate, and the effective focal length f2 of the second lens satisfy: 0.6<FG1/f2<1.4.

In some embodiments, the combined focal length FG2 of the third lens and the second quarter-wave plate and the polarizer, and the effective focal length f4 of the fourth lens satisfy:

$$1.3 < FG 2 / f 4 < 3.2 .$$

In some embodiments, the axial distance SAG21 from the intersection of the first side surface of the second lens and the optical axis to the effective radius vertex of the first side surface of the second lens, and the axial distance SAG11 from the intersection of the first side surface of the first lens and the optical axis to the effective radius vertex of the first side surface of the first lens satisfy: 0.4<SAG21/SAG11<1.0.

In some embodiments, the axial distance SAG41 from the intersection of the first side surface of the fourth lens and the optical axis to the effective radius vertex of the first side surface of the fourth lens, the axial distance SAG42 from the intersection of the second side surface of the fourth lens and the optical axis to the effective radius vertex of the second side surface of the fourth lens, and the center thickness CT4 of the fourth lens on the optical axis satisfy:

$$0.2 ( \vert SAG 41 \vert + \vert SAG 42 \vert ) / CT 4 < 1.9 .$$

In some embodiments, the reflective polarizing element is arranged on the second side surface of the first lens and is at least partially attached to the second side surface of the first lens; the first quarter-wave plate is arranged on the second side surface of the reflective polarizing element and is at least partially attached to the second side surface of the reflective polarizing element; and the partially reflective element is arranged on the second side surface of the third lens and is at least partially attached to the second side surface of the third lens; the second quarter-wave plate is arranged on the second side surface of the partially reflective element and is at least partially attached to the second side surface of the partially reflective element; the polarizer is arranged on the second side surface of the second quarter-wave plate and is at least partially attached to the second side surface of the second quarter-wave plate.

According to the optical system provided by embodiments of the present application, a four-lens polarized folded optical path is adopted. By reasonably configuring the focal length, surface shape, center thickness on the optical axis, etc., of each lens of the optical system, the body height can be better compressed and a compact design of the optical system can be achieved. Provided that f3/f1 satisfies a reasonable range, by precisely controlling the axial distance and thickness ratio between the lenses, the aberration performance of the optical system can be optimized, and imaging clarity and accuracy can be improved; at the same time, it helps to improve the vibration resistance of the optical system, making images more stable and clear; in addition, by controlling the size and layout of the lenses, the volume and weight of the device can be reduced, improving portability and comfort. In summary, the optical system provided by embodiments of the present application, through optical design and optimization, for example, by controlling the axial distance or thickness ratio between lenses, can optimize at least one of the aberration performance, imaging clarity, and accuracy of the optical system, thereby achieving optimization effects such as optical system imaging performance, vibration resistance, and compactness.

### BRIEF DESCRIPTION OF THE DRAWINGS

Other features, objectives, and advantages of the present application will become more apparent from the detailed description of non-limiting embodiments made with reference to the following accompanying drawings:

FIG. 1 shows a schematic structural diagram of an optical system according to Embodiment 1 of the present application;

FIGS. 2A, 2B, and 2C respectively show the longitudinal aberration curve, astigmatism curve, and distortion curve of the optical system according to Embodiment 1 of the present application;

FIG. 3 shows the MTF curve of the optical system according to Embodiment 1 of the present application;

FIG. 4 shows a schematic structural diagram of an optical system according to Embodiment 2 of the present application;

FIGS. 5A, 5B, and 5C respectively show the longitudinal aberration curve, astigmatism curve, and distortion curve of the optical system according to Embodiment 2 of the present application;

FIG. 6 shows the MTF curve of the optical system according to Embodiment 2 of the present application;

FIG. 7 shows a schematic structural diagram of the optical system according to Embodiment 2 of the present application;

FIGS. 8A, 8B, and 8C respectively show the longitudinal aberration curve, astigmatism curve, and distortion curve of the optical system according to Embodiment 3 of the present application;

FIG. 9 shows the MTF curve of the optical system according to Embodiment 3 of the present application;

FIG. 10 shows a schematic structural diagram of an optical system according to Embodiment 4 of the present application;

FIGS. 11A, 11B, and 11C respectively show the longitudinal aberration curve, astigmatism curve, and distortion curve of the optical system according to Embodiment 4 of the present application;

FIG. 12 shows the MTF curve of the optical system according to Embodiment 4 of the present application;

FIG. 13 shows a schematic structural diagram of an optical system according to Embodiment 5 of the present application;

FIGS. 14A, 14B, and 14C respectively show the longitudinal aberration curve, astigmatism curve, and distortion curve of the optical system according to Embodiment 5 of the present application; and

FIG. 15 shows the MTF curve of the optical system according to Embodiment 5 of the present application.

### DETAILED DESCRIPTION OF EMBODIMENTS

For a better understanding of the present application, various aspects of the present application will be described in more detail with reference to the accompanying drawings. It should be understood that these detailed descriptions are merely descriptive of exemplary embodiments of the present application and are not intended to limit the scope of the present application in any way. Throughout the specification, identical reference numerals refer to identical elements. The expression “and/or” comprises any and all combinations of one or more of the associated listed items.

It should be noted that in this specification, expressions such as first, second, third, fourth, etc., are used merely to distinguish one feature from another, and do not imply any limitation on the features. Therefore, without departing from the teachings of the present application, a first lens discussed below may also be referred to as a second lens or a third lens.

In the figures, for ease of illustration, the thickness, size, and shape of the lenses have been slightly exaggerated. Specifically, the spherical or aspherical shapes shown in the figures are shown by way of example. That is, the spherical or aspherical shapes are not limited to the spherical or aspherical shapes shown in the figures. The figures are for illustration only and are not strictly drawn to scale.

Herein, the paraxial region refers to the region near the optical axis. If a lens surface is a convex surface and the position of the convex surface is not defined, it means that the lens surface is convex at least in the paraxial region; if a lens surface is a concave surface and the position of the concave surface is not defined, it means that the lens surface is concave at least in the paraxial region.

It should also be understood that the terms “comprise,” “comprising,” “have,” “include,” and/or “including,” when used in this specification, indicate the presence of the stated features, elements, and/or components, but do not preclude the presence or addition of one or more other features, elements, components, and/or combinations thereof. Furthermore, when an expression such as “at least one of . . . ” appears after a list of listed features, it modifies the entire list of features, rather than modifying individual elements in the list. Furthermore, when describing embodiments of the present application, the use of “may” indicates “one or more embodiments of the present application.” And, the term “exemplary” is intended to mean an example or illustration.

Unless otherwise defined, all terms used herein (comprising technical and scientific terms) have the same meaning as commonly understood by one of ordinary skill in the art to which this application belongs. It should also be understood that terms (e.g., terms defined in common dictionaries) should be interpreted as having a meaning consistent with their meaning in the context of the relevant art and will not be interpreted in an idealized or overly formal sense unless expressly so defined herein.

It should be noted that, in the absence of conflict, the embodiments and features within the embodiments of the present application may be combined with each other. The following embodiments only express several embodiments of the present application, and their descriptions are more specific and detailed, but they should not therefore be understood as limiting the scope of the patent of the present application. It should be pointed out that for those skilled in the art, several deformations and improvements can be made without departing from the concept of the present application, and these all fall within the protection scope of the present application. For example, the lens groups (namely the first lens to the fourth lens), lens barrel structures, and spacer elements in each embodiment of the present application can be arbitrarily combined, and are not limited to the lens group in one embodiment being able to be combined only with the lens barrel structure, spacer elements, etc., of that embodiment.

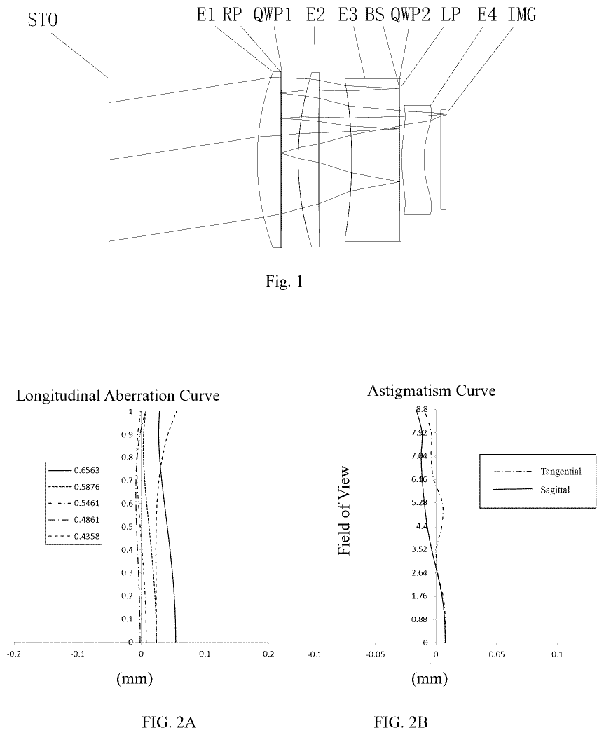

The features, principles, and other aspects of the present application are described in detail below. Referring to FIG. 1, a first aspect of the present application provides an optical system, which may comprise, arranged sequentially along an optical axis from a first side to a second side: a first lens E1, a reflective polarizing element RP, a first quarter-wave plate QWP1, a second lens E2, a third lens E3, a partially reflective element BS, a second quarter-wave plate QWP2, a polarizer LP, and a fourth lens E4. Any adjacent lenses may have an air interval. In an exemplary embodiment, the second side of the optical system may also comprise a display screen.

In an exemplary embodiment, the first side of the optical system may be, for example, near the human eye side, and the second side may be, for example, near the display side. Accordingly, each optical element (first lens, reflective polarizing element, first quarter-wave plate, second lens, third lens, partially reflective element, second quarter-wave plate, polarizer, fourth lens, etc.) has at least one first side surface relatively closer to the human eye side, and at least one second side surface relatively closer to the display side.

In an exemplary embodiment, the first lens E1 may have positive refractive power. The second lens E2 may have positive refractive power. The third lens E3 may have negative refractive power. The fourth lens E4 may have negative refractive power.

In an exemplary embodiment, the first side surface of the first lens E1 may be a convex surface, and the second side surface may be a plane. The reflective polarizing element RP may be arranged on the second side surface (surface closer to the display side) of the first lens E1 and be at least partially attached to the second side surface of the first lens E1. The first quarter-wave plate QWP1 may be arranged on the second side surface (surface closer to the display side) of the reflective polarizing element RP and be at least partially attached to the second side surface of the reflective polarizing element RP. Exemplarily, the reflective polarizing element RP and the first quarter-wave plate QWP1 may be sequentially attached to the second side surface of the first lens E1. The two may also be compounded together to achieve one-time attachment, thereby improving production efficiency and reducing costs. At the same time, compounding the two can also avoid angle deviation between the optical axis of the reflective polarizing element and the optical axis of the first quarter-wave plate caused by the attachment process, thereby improving imaging quality.

In an exemplary embodiment, the first side surface of the second lens E2 may be a convex surface, and the second side surface may be a convex surface or a concave surface.

In an exemplary embodiment, the first side surface of the third lens E3 may be a concave surface, and the second side surface may be a plane. The partially reflective element BS may be arranged on the second side surface of the third lens E3 and be at least partially attached to the second side surface of the third lens E3. The second quarter-wave plate QWP2 may be arranged on the second side surface of the partially reflective element BS and be at least partially attached to the second side surface of the partially reflective element BS. The polarizer LP may be arranged on the second side surface of the second quarter-wave plate QWP2 and be at least partially attached to the second side surface of the second quarter-wave plate QWP2. Exemplarily, the partially reflective element BS, the second quarter-wave plate QWP2, and the polarizer LP may be sequentially attached to the second side surface of the third lens E3.

In an exemplary embodiment, the first side surface of the fourth lens E4 may be a convex surface or a concave surface, and the second side surface may be a concave surface or a convex surface.

According to the optical system of an exemplary embodiment of the present application, when light passes through the reflective polarizing element, the reflective polarizing element can reflect light in a certain direction and can transmit light orthogonal to the reflected light. A quarter-wave plate can be used to convert between circularly polarized light and linearly polarized light to achieve light path folding. The partially reflective element can be a partially reflective layer (e.g., a semi-transparent and semi-reflective film) attached or coated on the second side surface of the second lens. The partially reflective layer has a semi-transmissive and semi-reflective effect on light. The function of the polarizer is to convert natural light emitted from the screen into linearly polarized light. Image light from the display screen passes through the visual optical system multiple times through refraction and reflection, and is finally projected to the user's eyes.

The optical system provided according to embodiments of the present application can be applied to head-mounted devices of AR or VR equipment. Specifically, it can serve as the visual optical system of the head-mounted device. By turning the optical path, the body length of the lens assembly can be compressed, thereby shifting the center of gravity of the head-mounted device backward and enhancing the consumer's experience.

In an exemplary embodiment, the effective focal length f1 of the first lens, the effective focal length f3 of the third lens, the center thickness CT3 of the third lens on the optical axis, the center thickness CTL of the polarizer on the optical axis, the center thickness CTQ2 of the second quarter-wave plate on the optical axis, the center thickness CT1 of the first lens on the optical axis, the center thickness CTR of the reflective polarizing element on the optical axis, and the center thickness CTQ1 of the first quarter-wave plate on the optical axis satisfy: −1.5<f3/f1<−1.0; 2≤(CT3+CTQ2+CTL)/(CT1+CTR+CTQ1)<2.9. By designing and optimizing the optical system, while ensuring that the ratio of f3/f1 is within a reasonable range, the light transmittance can be optimized by controlling the thickness ratio of related optical elements within a certain range. Specifically, adjusting the thickness ratio within a suitable range of 2≤(CT3+CTQ2+CTL)/(CT1+CTR+CTQ1)<2.9 can minimize light loss and reflection, thereby improving the transmittance and efficiency of the optical system. Among them, the thickness ratio of the optical elements plays an important role in the balance of the optical path. By reasonably adjusting the thickness ratio, balanced light transmission between different elements can be achieved, avoiding excessive scattering and diffraction of light, thereby maintaining the clarity and quality of the image. In addition, when light propagates through elements of different thicknesses, refraction and deflection occur. By controlling an appropriate thickness ratio, these distortions can be corrected, which helps to correct distortions in the optical system and improve the geometric shape and accuracy of the image.

In an exemplary embodiment, the effective focal length f2 of the second lens and the radius of curvature R3 of the first side surface of the second lens satisfy: 1≤f2/R3<1.8. By controlling the ratio between the focal length and the radius of curvature of the lens within a certain range, the generation of astigmatism can be effectively reduced. Astigmatism is a common aberration in optical systems that can lead to image distortion and blur. Satisfying this conditional formula can reduce astigmatism and improve the clarity and accuracy of imaging.

In an exemplary embodiment, the distance TD on the optical axis from the first side surface of the first lens to the second side surface of the fourth lens and the effective focal length f of the optical system satisfy: 0.5<TD/f<0.6. By satisfying this conditional formula, the ratio of the focal length of the optical system and the distance between the lenses can be optimized, improving the clarity, sharpness, and resolution of the image, making the imaging results more accurate and realistic, thereby achieving optimal imaging quality. At the same time, the layout and structure of the lenses can also be optimized, making the optical system more stable and improving its vibration resistance, which helps to maintain image stability and reduce the impact of vibration on imaging, especially in application scenarios requiring movement or vibration.

In an exemplary embodiment, the effective focal length f4 of the fourth lens and the effective focal length f of the optical system satisfy: −1.4<f4/f≤−0.7. The focal length ratio of the lenses is a key parameter in optical system design. By satisfying −1.4<f4/f≤−0.7, the performance of the optical system can be optimized, comprising improving imaging quality, enhancing light focusing capability, and reducing distortion.

In an exemplary embodiment, the refractive index N3 of the third lens, the refractive index N1 of the first lens, the Abbe number V3 of the third lens, and the Abbe number V1 of the first lens satisfy: 1.0<N3/N1<1.2; 0.4<V3/V1<0.7. The refractive index and Abbe number of lenses are important factors affecting image quality. By selecting the ratio of the refractive indices and Abbe numbers of the lenses, color correction of the optical system can be achieved, which helps to reduce chromatic aberration and dispersion phenomena, improving the color accuracy and clarity of the image. Satisfying these conditional formulas can optimize the performance of the optical system, comprising improving imaging quality, reducing chromatic aberration and dispersion phenomena, making images clearer and more realistic, and better reproducing real-world colors. In addition, by optimizing the color correction and image quality of the optical system, visual fatigue can be reduced, alleviating the user's visual burden.

In an exemplary embodiment, the effective focal length f of the optical system, the center thickness CT1 of the first lens on the optical axis, the center thickness CTR of the reflective polarizing element on the optical axis, and the center thickness CTQ1 of the first quarter-wave plate on the optical axis satisfy: 11<f/(CT1+CTR+CTQ1)<12.4. Satisfying this conditional formula can achieve a compact design of the optical system, reduce the volume and weight of the device, improve wearing convenience, and effectively reduce astigmatism, improving the clarity and accuracy of imaging.

In an exemplary embodiment, the effective focal length f1 of the first lens and the radius of curvature R1 of the first side surface of the first lens satisfy: 1.3<f1/R1<2.1. Satisfying this conditional formula, by reasonably configuring the ratio of the radius of curvature and focal length of the lens, can reduce distortions in the optical system and improve the accuracy and realism of imaging. At the same time, it can also optimize the performance of the optical system, comprising improving imaging quality, enhancing light focusing capability, etc.

In an exemplary embodiment, the center thickness CT3 of the third lens on the optical axis, and the sum of the center thicknesses of the first lens to the fourth lens on the optical axis ΣCT satisfy: 0.35<CT3/ΣCT<0.55. Satisfying this conditional formula can optimize the performance of the optical system, comprising improving imaging quality, enhancing light focusing capability, and reducing distortion, and also helps to achieve a lightweight design of the optical system.

In an exemplary embodiment, the entrance pupil diameter EPD of the optical system and the distance TD on the optical axis from the first side surface of the first lens to the second side surface of the fourth lens satisfy: 0.9<EPD/TD<1.0. The brightness of the optical system is directly related to its light transmittance. The ratio of the entrance pupil diameter EPD and the optical axis distance (TD) can affect the light transmittance of the optical system. By satisfying this conditional formula, the light transmittance can be maximized, energy loss can be reduced, and thus the brightness of the optical system can be increased, improving the efficiency of the optical system. This is particularly important for virtual reality devices, as it can provide brighter, clearer images and enhance the user's visual experience. Furthermore, by adjusting the ratio of the entrance pupil diameter and the optical axis distance, the field of view of the optical system can also be increased. This is equally important for virtual reality devices, as it can provide a wider field of view, enhancing immersion and realism.

In an exemplary embodiment, the effective focal length f3 of the third lens and the radius of curvature R5 of the first side surface of the third lens satisfy: 1.3<f3/R5<1.5. Satisfying this conditional formula, by configuring an appropriate ratio of the lens focal length and radius of curvature, can reduce aberrations in the optical system and improve imaging clarity and the optical performance of the optical system.

In an exemplary embodiment, the combined focal length FG1 of the first lens and the reflective polarizing element and the first quarter-wave plate, and the effective focal length f2 of the second lens satisfy: 0.6<FG1/f2<1.4. Satisfying this conditional formula can maximize light transmittance, reduce energy loss, and improve the efficiency of the optical system. At the same time, it can improve the resolution of the optical system, making images clearer and more detailed. In addition, it can optimize the chromatic aberration performance of the optical system, improving the accuracy and realism of imaging.

In an exemplary embodiment, the combined focal length FG2 of the third lens and the second quarter-wave plate and the polarizer, and the effective focal length f4 of the fourth lens satisfy: 1.3<FG2/f4<3.2. Satisfying this conditional formula can optimize the chromatic aberration of the optical system, avoid colored edges or chromatic aberration phenomena in images, and also improve the resolution of the optical system, restoring image clarity and more details more clearly.

In an exemplary embodiment, the axial distance SAG21 from the intersection of the first side surface of the second lens and the optical axis to the effective radius vertex of the first side surface of the second lens, and the axial distance SAG11 from the intersection of the first side surface of the first lens and the optical axis to the effective radius vertex of the first side surface of the first lens satisfy: 0.4<SAG21/SAG11<1.0. Satisfying this conditional formula can reduce the ratio of the axial distance between lenses, thereby reducing the generation of aberrations and improving imaging clarity and accuracy.

In an exemplary embodiment, the axial distance SAG41 from the intersection of the first side surface of the fourth lens and the optical axis to the effective radius vertex of the first side surface of the fourth lens, the axial distance SAG42 from the intersection of the second side surface of the fourth lens and the optical axis to the effective radius vertex of the second side surface of the fourth lens, and the center thickness CT4 of the fourth lens on the optical axis satisfy: 0.2< (|SAG41|+|SAG42|)/CT4<1.9. Considering that the optical system may be affected by vibrations during use, this can lead to blurred or distorted images. By satisfying this conditional formula, the structure and stability of the lens can be optimized, and the vibration resistance of the optical system can be improved, making images more stable and clear. Furthermore, by controlling the ratio of the axial distance and center thickness of the fourth lens, a compact design of the optical system can also be achieved.

Referring to FIG. 1, a second aspect of the present application provides an optical system, which may comprise, arranged sequentially along an optical axis from a first side to a second side: a first lens E1, a reflective polarizing element RP, a first quarter-wave plate QWP1, a second lens E2, a third lens E3, a partially reflective element BS, a second quarter-wave plate QWP2, a polarizer LP, and a fourth lens E4. Any adjacent lenses may have an air interval. In an exemplary embodiment, the second side of the optical system may also comprise a display screen.

Wherein, the effective focal length f1 of the first lens, the effective focal length f3 of the third lens, the entrance pupil diameter EPD of the optical system, and the distance TD on the optical axis from the first side surface of the first lens to the second side surface of the fourth lens satisfy: −1.5<f3/f1<−1.0; 0.9<EPD/TD<1.0. By designing and optimizing the optical system, while ensuring that the ratio of f3/f1 is within a reasonable range, the light transmittance can be optimized by controlling the ratio of the entrance pupil diameter EPD and the optical axis distance (TD) within a certain range. Among them, the brightness of the optical system is directly related to its light transmittance. The ratio of the entrance pupil diameter and the optical axis distance can affect the light transmittance of the optical system. By satisfying this conditional formula 0.9<EPD/TD<1.0, the light transmittance can be maximized, energy loss can be reduced, and thus the brightness of the optical system can be increased, improving the efficiency of the optical system. This is particularly important for virtual reality devices, as it can provide brighter, clearer images and enhance the user's visual experience. Furthermore, by adjusting the ratio of the entrance pupil diameter and the optical axis distance, the field of view of the optical system can also be increased. This is equally important for virtual reality devices, as it can provide a wider field of view, enhancing immersion and realism.

According to the optical system of the above embodiments of the present application, a four-lens folded optical path scheme can be adopted, and by adopting a polarized folded optical path method, the body height can be better compressed and imaging quality can be improved. In addition, by reasonably distributing the focal length and surface shape of each lens, the center thickness of each lens, and the axial spacing between each lens, the incident light rays can be effectively converged, the total optical length can be reduced, and manufacturability can be improved, making the optical system more conducive to production and processing.

In embodiments of the present application, the first side surface or the second side surface of any lens of the optical system may be an aspherical surface. Aspherical lenses have better radius of curvature characteristics and have the advantages of improving distortion aberration and astigmatism aberration. Using aspherical lenses can eliminate aberrations that occur during imaging as much as possible, thereby improving imaging quality.

Hereinafter, Embodiments 1 to 5 of the optical system applicable to the above exemplary embodiments will be further described with reference to the accompanying drawings and in conjunction with the embodiments.

### Embodiment 1

FIG. 1 shows a schematic structural diagram of an optical system according to Embodiment 1 of the present application.

As shown in FIG. 1, the optical system comprises, arranged sequentially along an optical axis from the human eye side to the display side: a first lens E1, a reflective polarizing element RP, a first quarter-wave plate QWP1, a second lens E2, a third lens E3, a partially reflective element BS, a second quarter-wave plate QWP2, a polarizer LP, and a fourth lens E4.

The optical system may further comprise an aperture stop STO arranged on the human eye side. The aperture stop STO may be arranged on the first side of the first lens E1.

In this embodiment, the first lens E1 has positive refractive power. The first side surface of the first lens E1 is a convex surface, and the second side surface is a plane. The reflective polarizing element RP and the first quarter-wave plate QWP1 are sequentially attached to the second side surface. The second lens E2 has positive refractive power. The first side surface is a convex surface, and the second side surface is a concave surface. The third lens E3 has a concave first side surface and a planar second side surface. The partially reflective element BS, the second quarter-wave plate QWP2, and the polarizer LP are sequentially attached to the second side surface. The fourth lens E4 has negative refractive power. The first side surface is a convex surface, and the second side surface is a concave surface. An optical element may also be disposed between the fourth lens E4 and the imaging surface (IMA), which may be a filter or protective glass.

Table 1 shows the basic parameter table of the optical system of Embodiment 1, wherein the units for radius of curvature and thickness/distance are all millimeters (mm). Image light from the display screen passes through the optical surfaces of each element sequentially and is finally projected into the human eye.

TABLE 1

| | | | | | Material | | | |
|---|---|---|---|---|---|---|---|---|
| Surface | | Surface | Radius of | Thickness/ | Refractive | Abbe | Refraction/ | Cone |
| Number | Optical element | Type | Curvature | Distance | Index | number | Reflection | coefficient |
| 0 | | spherical | Infinity | −105000.00 | | | Refraction | |
| 1 | Aperture Stop | spherical | Infinity | 21.0000 | | | Refraction | |
| | (STO) | | | | | | | |
| 2 | First lens (E1) | spherical | 35.9116 | 3.2818 | 1.555 | 63.37 | Refraction | |
| 3 | Reflective | spherical | Infinity | 0.1100 | 1.502 | 57.00 | Refraction | |
| | Polarizing | | | | | | | |
| | Element (RP) | | | | | | | |
| 4 | First Quarter- | spherical | Infinity | 0.1100 | 1.502 | 57.00 | Refraction | |
| | Wave Plate | | | | | | | |
| | (QWP1) | | | | | | | |
| 5 | | spherical | Infinity | 2.2987 | | | Refraction | |
| 6 | Second lens (E2) | spherical | 40.6132 | 2.9146 | 1.594 | 60.62 | Refraction | |
| 7 | | spherical | 1346.4432 | 4.6651 | | | Refraction | |
| 8 | Third lens (E3) | spherical | −66.1780 | 6.7485 | 1.747 | 27.79 | Refraction | |
| 9 | Partially | spherical | Infinity | −6.7485 | 1.747 | 27.79 | Reflection | |
| | reflective | | | | | | | |
| | element (BS) | | | | | | | |
| 10 | | spherical | −66.1780 | −4.6651 | | | Refraction | |
| 11 | | spherical | 1346.4432 | −2.9146 | 1.594 | 60.62 | Refraction | |
| 12 | | spherical | 40.6132 | −2.2987 | | | Refraction | |
| 13 | | spherical | Infinity | −0.1100 | 1.502 | 57.00 | Refraction | |
| 14 | | spherical | Infinity | −0.1100 | 1.502 | 57.00 | Refraction | |
| 15 | Reflective | spherical | Infinity | 0.1100 | 1.502 | 57.00 | Reflection | |
| | Polarizing | | | | | | | |
| | Element (RP) | | | | | | | |
| 16 | | spherical | Infinity | 0.1100 | 1.502 | 57.00 | Refraction | |
| 17 | | spherical | Infinity | 2.2987 | | | Refraction | |
| 18 | Second lens (E2) | spherical | 40.6132 | 2.9146 | 1.594 | 60.62 | Refraction | |
| 19 | | spherical | 1346.4432 | 4.6651 | | | Refraction | |
| 20 | Third lens (E3) | spherical | −66.1780 | 6.7485 | 1.747 | 27.79 | Refraction | |
| 21 | Second Quarter- | spherical | Infinity | 0.1000 | 1.502 | 57.00 | Refraction | |
| | Wave Plate | | | | | | | |
| | (QWP2) | | | | | | | |
| 22 | Polarizer (LP) | spherical | Infinity | 0.1500 | 1.502 | 57.00 | Refraction | |
| 23 | | spherical | Infinity | 0.1000 | | | Refraction | |
| 24 | Fourth lens (E4) | aspherical | 22.1164 | 3.1420 | 1.679 | 19.24 | Refraction | 0.9812 |
| 25 | | aspherical | 13.0959 | 2.3693 | | | Refraction | −9.9765 |
| 26 | Protective glass | spherical | Infinity | 0.7100 | 1.519 | 64.17 | Refraction | |
| 27 | | spherical | Infinity | 0.3000 | | | Refraction | |
| 28 | Image surface | spherical | Infinity | 0.0000 | | | Refraction | |
| | (IMG) | | | | | | | |

In this embodiment, both the first side surface and the second side surface of the fourth lens E4 are aspherical. The surface profile x of each aspherical lens can be defined by, but is not limited to, the following aspherical surface formula:

$$x = \frac{{ch}^{2}}{1 \text{?} \sqrt{1 - ( k \text{?} 1 ) c \text{?} h \text{?}}} \text{?} \sum Ath \text{?} \qquad ( 1 )$$

$$\text{?} \text{indicates text missing or illegible when filed}$$

Wherein, x is the sagittal height of the aspherical surface, which is the distance from the vertex of the aspherical surface in the direction of the optical axis at a height h; c is the paraxial curvature of the aspherical surface, c=1/R (that is, the paraxial curvature c is the reciprocal of the radius of curvature R in Table 1 above); k is the cone coefficient; Ai is the i-th order correction coefficient of the aspherical surface.

Table 2 shows the high-order coefficients A4, A6, A8, A10, A12, A14, A16, A18, and A20 that can be used for the aspherical lens surfaces S24 and S25 in Embodiment 1.

TABLE 2

Surface number

| Coefficient | S24 | S25 |
|---|---|---|
| A4 | −7.9931E−01 | −6.3669E−01 |
| A6 | −3.9385E−02 | −4.2803E−01 |
| A8 | −1.7119E−03 | −6.1338E−02 |
| A10 | −1.3914E−03 | −4.4223E−02 |
| A12 | 6.7489E−04 | −2.3695E−02 |
| A14 | 6.5301E−05 | −1.7514E−02 |
| A16 | −6.2995E−06 | −6.3956E−03 |
| A18 | 5.8711E−05 | −1.4767E−03 |
| A20 | 0.0000E+00 | 0.0000E+00 |

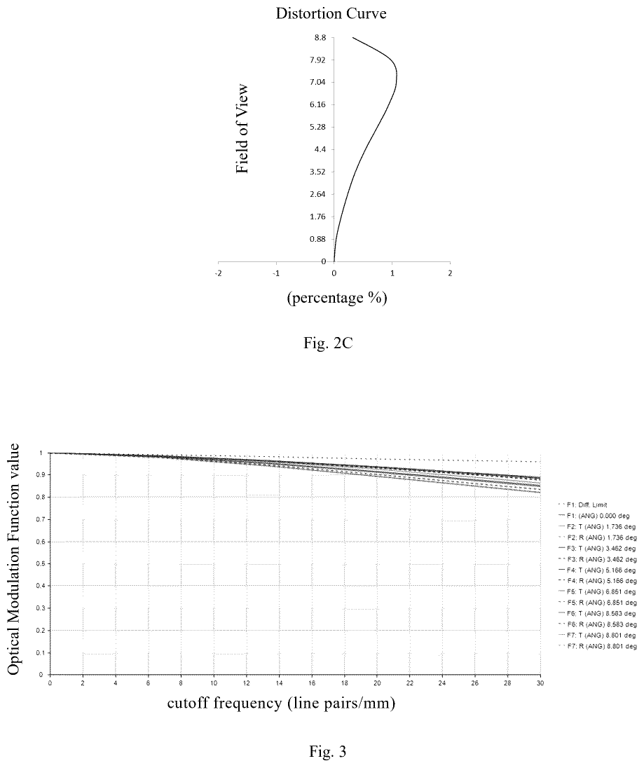

FIG. 2A shows the longitudinal aberration curve of the optical system of Embodiment 1, which represents the deviation of the converging point of light rays of different wavelengths after passing through the optical system. FIG. 2B shows the astigmatism curve of the optical system of Embodiment 1, which represents the curvature of a tangential plane and the curvature of a sagittal plane corresponding to different field angles. FIG. 2C shows the distortion curve of the optical system of Embodiment 1, which represents the distortion magnitude corresponding to different field angles. From FIGS. 2A to 2C, it can be seen that the optical system given in Embodiment 1 can achieve good imaging quality.

FIG. 3 shows the MTF curve of the optical imaging system of Embodiment 1. From FIG. 3, it can be seen that the optical system of this embodiment has good contrast within a spatial frequency of 30 lp/mm, and the imaging is clear.

### Embodiment 2

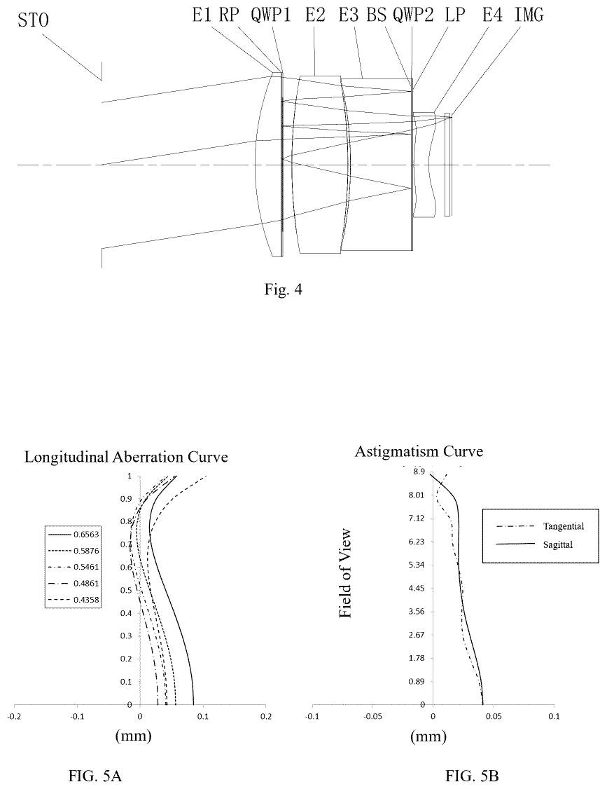

FIG. 4 shows a schematic structural diagram of an optical system according to Embodiment 2 of the present application. In this embodiment and the following embodiments, for the sake of brevity, some descriptions similar to those in Embodiment 1 will be omitted.

As shown in FIG. 4, the optical system comprises, arranged sequentially along an optical axis from the human eye side to the display side: a first lens E1, a reflective polarizing element RP, a first quarter-wave plate QWP1, a second lens E2, a third lens E3, a partially reflective element BS, a second quarter-wave plate QWP2, a polarizer LP, and a fourth lens E4.

The optical system may further comprise an aperture stop STO arranged on the human eye side. The aperture stop STO may be arranged on the first side of the first lens E1.

In this embodiment, the first lens E1 has positive refractive power. The first side surface of the first lens E1 is a convex surface, and the second side surface is a plane. The reflective polarizing element RP and the first quarter-wave plate QWP1 are sequentially attached to the second side surface. The second lens E2 has positive refractive power. The first side surface is a convex surface, and the second side surface is a convex surface. The third lens E3 has a concave first side surface and a planar second side surface. The partially reflective element BS, the second quarter-wave plate QWP2, and the polarizer LP are sequentially attached to the second side surface. The fourth lens E4 has negative refractive power. The first side surface is a convex surface, and the second side surface is a concave surface.

Table 3 shows the basic parameter table of the optical system of Embodiment 2, wherein the units for radius of curvature and thickness/distance are all millimeters (mm).

TABLE 3

| | | | | | Material | | | |
|---|---|---|---|---|---|---|---|---|
| Surface | | Surface | Radius of | Thickness/ | Refractive | Abbe | Refraction/ | Cone |
| Number | Optical element | Type | Curvature | Distance | Index | number | Reflection | coefficient |
| 0 | | spherical | Infinity | −105000.00 | | | Refraction | |
| 1 | Aperture Stop | spherical | Infinity | 21.0000 | | | Refraction | |
| | (STO) | | | | | | | |
| 2 | First lens (E1) | spherical | 33.9211 | 3.5920 | 1.748 | 44.85 | Refraction | |
| 3 | Reflective | spherical | Infinity | 0.1100 | 1.502 | 57.00 | Refraction | |
| | Polarizing | | | | | | | |
| | Element (RP) | | | | | | | |
| 4 | First Quarter- | spherical | Infinity | 0.1100 | 1.502 | 57.00 | Refraction | |
| | Wave Plate | | | | | | | |
| | (QWP1) | | | | | | | |
| 5 | | spherical | Infinity | 1.2350 | | | Refraction | |
| 6 | Second lens (E2) | spherical | 66.7825 | 7.6865 | 1.507 | 70.49 | Refraction | |
| 7 | | spherical | −66.2028 | 0.2646 | | | Refraction | |
| 8 | Third lens (E3) | spherical | −51.6338 | 8.4000 | 1.762 | 27.58 | Refraction | |
| 9 | Partially reflective | spherical | Infinity | −8.4000 | 1.762 | 27.58 | Reflection | |
| | element (BS) | | | | | | | |
| 10 | | spherical | −51.6338 | −0.2646 | | | Refraction | |
| 11 | | spherical | −66.2028 | −7.6865 | 1.507 | 70.49 | Refraction | |
| 12 | | spherical | 66.7825 | −1.2350 | | | Refraction | |
| 13 | | spherical | Infinity | −0.1100 | 1.502 | 57.00 | Refraction | |
| 14 | | spherical | Infinity | −0.1100 | 1.502 | 57.00 | Refraction | |
| 15 | Reflective | spherical | Infinity | 0.1100 | 1.502 | 57.00 | Reflection | |
| | Polarizing | | | | | | | |
| | Element (RP) | | | | | | | |
| 16 | | spherical | Infinity | 0.1100 | 1.502 | 57.00 | Refraction | |
| 17 | | spherical | Infinity | 1.2350 | | | Refraction | |
| 18 | Second lens (E2) | spherical | 66.7825 | 7.6865 | 1.507 | 70.49 | Refraction | |
| 19 | | spherical | −66.2028 | 0.2646 | | | Refraction | |
| 20 | Third lens (E3) | spherical | −51.6338 | 8.4000 | 1.762 | 27.58 | Refraction | |
| 21 | Second Quarter- | spherical | Infinity | 0.1000 | 1.502 | 57.00 | Refraction | |
| | Wave Plate | | | | | | | |
| | (QWP2) | | | | | | | |
| 22 | Polarizer (LP) | spherical | Infinity | 0.1500 | 1.502 | 57.00 | Refraction | |
| 23 | | spherical | Infinity | 0.1057 | | | Refraction | |
| 24 | Fourth lens (E4) | aspherical | 18.1882 | 2.0454 | 1.500 | 57.28 | Refraction | −8.4753 |
| 25 | | aspherical | 10.1216 | 2.1907 | | | Refraction | −0.0685 |
| 26 | Protective glass | spherical | Infinity | 0.7100 | 1.519 | 64.17 | Refraction | |
| 27 | | spherical | Infinity | 0.3000 | | | Refraction | |
| 28 | Image surface | spherical | Infinity | 0.0000 | | | Refraction | |
| | (IMG) | | | | | | | |

In this embodiment, both the first side surface and the second side surface of the fourth lens E4 are aspherical. The surface profile x of each aspherical lens can be defined by, but is not limited to, the formula (1) given in the foregoing Embodiment 1.

Table 4 shows the high-order coefficients A4, A6, A8, A10, A12, A14, A16, A18, and A20 that can be used for the aspherical lens surfaces S24 and S25 in Embodiment 2.

TABLE 4

Surface number

| Coefficient | S24 | S25 |
|---|---|---|
| A4 | −1.5200E+00 | −5.4807E+00 |
| A6 | 1.4310E−02 | −8.5773E−01 |
| A8 | 6.2137E−02 | −1.9172E+00 |
| A10 | 4.3495E−02 | −2.4615E+00 |
| A12 | 2.8231E−02 | −1.9482E+00 |
| A14 | 1.1967E−02 | −1.0110E+00 |
| A16 | 2.6612E−03 | −3.2794E−01 |
| A18 | 1.3535E−04 | −5.0105E−02 |
| A20 | 0.0000E+00 | 0.0000E+00 |

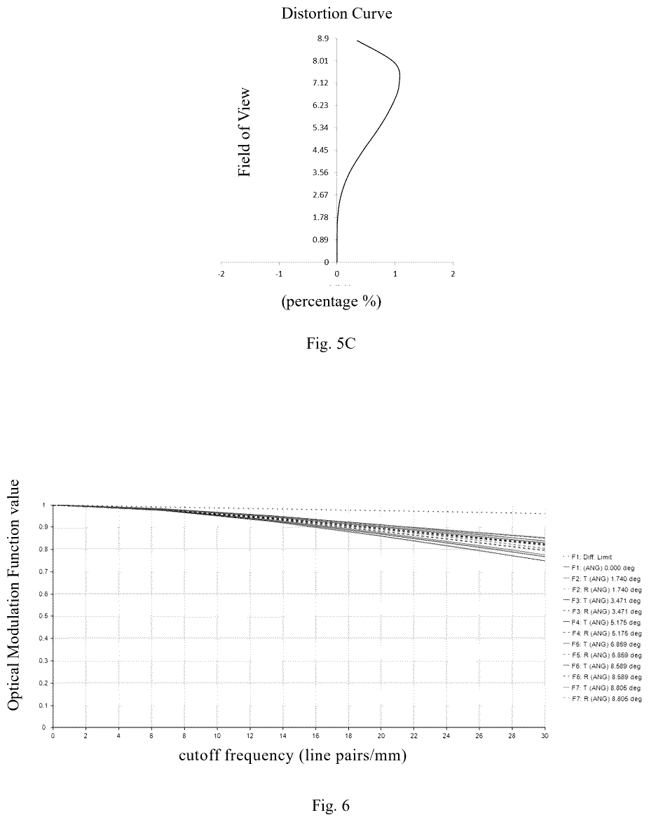

FIG. 5A shows the longitudinal aberration curve of the optical system of Embodiment 2, which represents the deviation of the converging point of light rays of different wavelengths after passing through the optical system. FIG. 5B shows the astigmatism curve of the optical system of Embodiment 2, which represents the curvature of a tangential plane and the curvature of a sagittal plane corresponding to different field angles. FIG. 5C shows the distortion curve of the optical system of Embodiment 2, which represents the distortion magnitude corresponding to different field angles. From FIGS. 5A to 5C, it can be seen that the optical system given in Embodiment 2 can achieve good imaging quality.

FIG. 6 shows the MTF curve of the optical imaging system of Embodiment 2. From FIG. 6, it can be seen that the optical system of this embodiment has good contrast within a spatial frequency of 30 lp/mm, and the imaging is clear.

### Embodiment 3

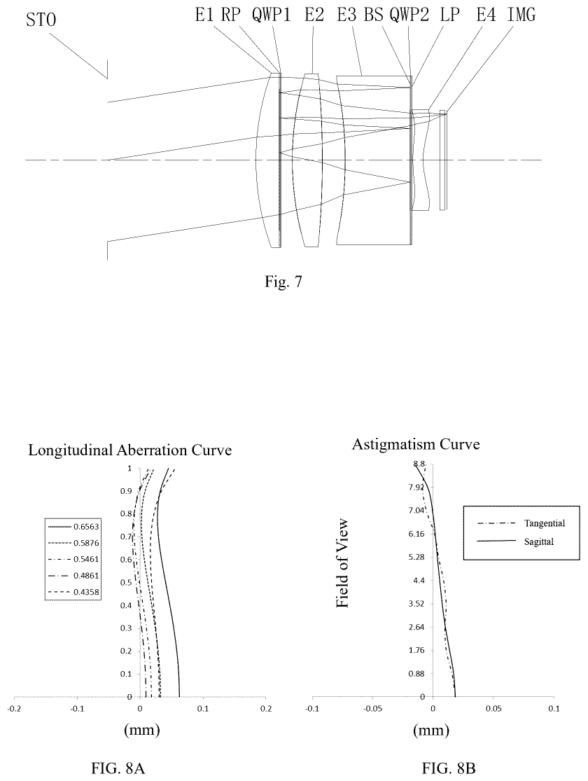

FIG. 7 shows a schematic structural diagram of an optical system according to Embodiment 3 of the present application.

As shown in FIG. 7, the optical system comprises, arranged sequentially along an optical axis from the human eye side to the display side: a first lens E1, a reflective polarizing element RP, a first quarter-wave plate QWP1, a second lens E2, a third lens E3, a partially reflective element BS, a second quarter-wave plate QWP2, a polarizer LP, and a fourth lens E4.

The optical system may further comprise an aperture stop STO arranged on the human eye side. The aperture stop STO may be arranged on the first side of the first lens E1.

In this embodiment, the first lens E1 has positive refractive power. The first side surface of the first lens E1 is a convex surface, and the second side surface is a plane. The reflective polarizing element RP and the first quarter-wave plate QWP1 are sequentially attached to the second side surface. The second lens E2 has positive refractive power. The first side surface is a convex surface, and the second side surface is a convex surface. The third lens E3 has a concave first side surface and a planar second side surface. The partially reflective element BS, the second quarter-wave plate QWP2, and the polarizer LP are sequentially attached to the second side surface. The fourth lens E4 has negative refractive power. The first side surface is a convex surface, and the second side surface is a concave surface.

Table 5 shows the basic parameter table of the optical system of Embodiment 3, wherein the units for radius of curvature and thickness/distance are all millimeters (mm).

TABLE 5

| | | | | | Material | | | |
|---|---|---|---|---|---|---|---|---|
| Surface | | Surface | Radius of | Thickness/ | Refractive | Abbe | Refraction/ | Cone |
| Number | Optical element | Type | Curvature | Distance | Index | number | Reflection | coefficient |
| 0 | | spherical | Infinity | −105000.00 | | | Refraction | |
| 1 | Aperture Stop (STO) | spherical | Infinity | 21.0000 | | | Refraction | |
| 2 | First lens (E1) | spherical | 36.1317 | 3.2973 | 1.489 | 70.40 | Refraction | |
| 3 | Reflective Polarizing | spherical | Infinity | 0.1100 | 1.502 | 57.00 | Refraction | |
| | Element (RP) | | | | | | | |
| 4 | First Quarter-Wave | spherical | Infinity | 0.1100 | 1.502 | 57.00 | Refraction | |
| | Plate (QWP1) | | | | | | | |
| 5 | | spherical | Infinity | 1.6269 | | | Refraction | |
| 6 | Second lens (E2) | spherical | 42.6451 | 4.2425 | 1.571 | 62.96 | Refraction | |
| 7 | | spherical | −127.8037 | 3.2356 | | | Refraction | |
| 8 | Third lens (E3) | spherical | −53.1692 | 9.1804 | 1.698 | 33.74 | Refraction | |
| 9 | Partially reflective | spherical | Infinity | −9.1804 | 1.698 | 33.74 | Reflection | |
| | element (BS) | | | | | | | |
| 10 | | spherical | −53.1692 | −3.2356 | | | Refraction | |
| 11 | | spherical | −127.8037 | −4.2425 | 1.571 | 62.96 | Refraction | |
| 12 | | spherical | 42.6451 | −1.6269 | | | Refraction | |
| 13 | | spherical | Infinity | −0.1100 | 1.502 | 57.00 | Refraction | |
| 14 | | spherical | Infinity | −0.1100 | 1.502 | 57.00 | Refraction | |
| 15 | Reflective Polarizing | spherical | Infinity | 0.1100 | 1.502 | 57.00 | Reflection | |
| | Element (RP) | | | | | | | |
| 16 | | spherical | Infinity | 0.1100 | 1.502 | 57.00 | Refraction | |
| 17 | | spherical | Infinity | 1.6269 | | | Refraction | |
| 18 | Second lens (E2) | spherical | 42.6451 | 4.2425 | 1.571 | 62.96 | Refraction | |
| 19 | | spherical | −127.8037 | 3.2356 | | | Refraction | |
| 20 | Third lens (E3) | spherical | −53.1692 | 9.1804 | 1.698 | 33.74 | Refraction | |
| 21 | Second Quarter-Wave | spherical | Infinity | 0.1000 | 1.502 | 57.00 | Refraction | |
| | Plate (QWP2) | | | | | | | |
| 22 | Polarizer (LP) | spherical | Infinity | 0.1500 | 1.502 | 57.00 | Refraction | |
| 23 | | spherical | Infinity | 0.1334 | | | Refraction | |
| 24 | Fourth lens (E4) | aspherical | 18.7631 | 1.4577 | 1.679 | 19.24 | Refraction | −17.6640 |
| 25 | | aspherical | 10.4821 | 2.3463 | | | Refraction | −3.6060 |
| 26 | Protective glass | spherical | Infinity | 0.7100 | 1.519 | 64.17 | Refraction | |
| 27 | | spherical | Infinity | 0.3000 | | | Refraction | |
| 28 | Image surface (IMG) | spherical | Infinity | 0.0000 | | | Refraction | |

In this embodiment, both the first side surface and the second side surface of the fourth lens E4 are aspherical. The surface profile X of each aspherical lens can be defined by, but is not limited to, the formula (1) given in the foregoing Embodiment 1.

Table 6 shows the high-order coefficients A4, A6, A8, A10, A12, A14, A16, A18, and A20 that can be used for the aspherical lens surfaces S24 and S25 in Embodiment 3.

TABLE 6

Surface number

| Coefficient | S24 | S25 |
|---|---|---|
| A4 | −1.1342E+00 | −1.4002E+00 |
| A6 | 7.2212E−03 | 8.6453E−02 |
| A8 | 8.8705E−03 | 9.8141E−02 |
| A10 | 3.7541E−03 | 8.4787E−02 |
| A12 | 6.3881E−03 | 5.2505E−02 |
| A14 | 2.5120E−03 | 2.2854E−02 |
| A16 | 9.3741E−04 | 7.7876E−03 |
| A18 | 2.8491E−04 | 2.0627E−03 |
| A20 | 0.0000E+00 | 0.0000E+00 |

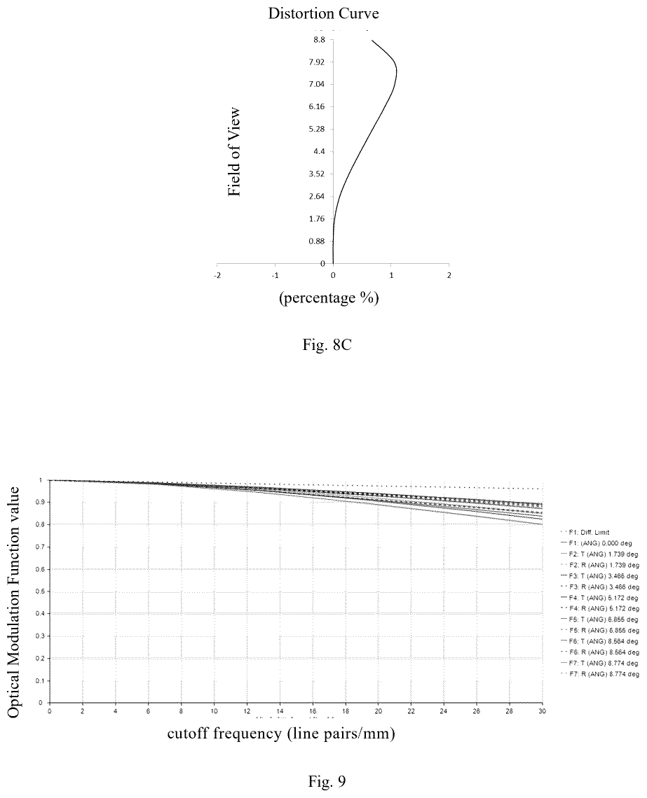

FIG. 8A shows the longitudinal aberration curve of the optical system of Embodiment 3, which represents the deviation of the converging point of light rays of different wavelengths after passing through the optical system. FIG. 8B shows the astigmatism curve of the optical system of Embodiment 3, which represents the curvature of a tangential plane and the curvature of a sagittal plane corresponding to different field angles. FIG. 8C shows the distortion curve of the optical system of Embodiment 3, which represents the distortion magnitude corresponding to different field angles. From FIGS. 8A to 8C, it can be seen that the optical system given in Embodiment 3 can achieve good imaging quality.

FIG. 9 shows the MTF curve of the optical imaging system of Embodiment 3. From FIG. 9, it can be seen that the optical system of this embodiment has good contrast within a spatial frequency of 30 lp/mm, and the imaging is clear.

### Embodiment 4

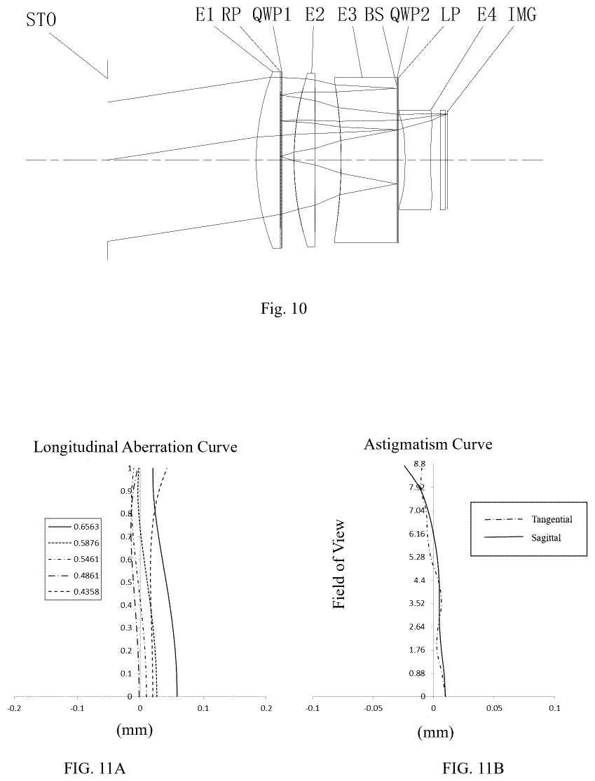

FIG. 10 shows a schematic structural diagram of an optical system according to Embodiment 4 of the present application.

As shown in FIG. 10, the optical system comprises, arranged sequentially along an optical axis from the human eye side to the display side: a first lens E1, a reflective polarizing element RP, a first quarter-wave plate QWP1, a second lens E2, a third lens E3, a partially reflective element BS, a second quarter-wave plate QWP2, a polarizer LP, and a fourth lens E4.

The optical system may further comprise an aperture stop STO arranged on the human eye side. The aperture stop STO may be arranged on the first side of the first lens E1.

In this embodiment, the first lens E1 has positive refractive power. The first side surface of the first lens E1 is a convex surface, and the second side surface is a plane. The reflective polarizing element RP and the first quarter-wave plate QWP1 are sequentially attached to the second side surface. The second lens E2 has positive refractive power. The first side surface is a convex surface, and the second side surface is a convex surface. The third lens E3 has a concave first side surface and a planar second side surface. The partially reflective element BS, the second quarter-wave plate QWP2, and the polarizer LP are sequentially attached to the second side surface. The fourth lens E4 has negative refractive power. The first side surface is a concave surface, and the second side surface is a concave surface.

Table 7 shows the basic parameter table of the optical system of Embodiment 4, wherein the units for radius of curvature and thickness/distance are all millimeters (mm).

TABLE 7

| | | | | | Material | | | |
|---|---|---|---|---|---|---|---|---|
| Surface | | Surface | Radius of | Thickness/ | Refractive | Abbe | Refraction/ | Cone |
| Number | Optical element | Type | Curvature | Distance | Index | number | Reflection | coefficient |
| 0 | | spherical | Infinity | −105000.00 | | | Refraction | |
| 1 | Aperture Stop (STO) | spherical | Infinity | 21.0000 | | | Refraction | |
| 2 | First lens (E1) | spherical | 34.4120 | 3.3974 | 1.541 | 62.70 | Refraction | |
| 3 | Reflective Polarizing | spherical | Infinity | 0.1100 | 1.502 | 57.00 | Refraction | |
| | Element (RP) | | | | | | | |
| 4 | First Quarter-Wave | spherical | Infinity | 0.1100 | 1.502 | 57.00 | Refraction | |
| | Plate (QWP1) | | | | | | | |
| 5 | | spherical | Infinity | 1.7165 | | | Refraction | |
| 6 | Second lens (E2) | spherical | 40.4165 | 2.9865 | 1.620 | 54.07 | Refraction | |
| 7 | | spherical | −3463.0335 | 3.6644 | | | Refraction | |
| 8 | Third lens (E3) | spherical | −67.3132 | 7.8692 | 1.762 | 27.58 | Refraction | |
| 9 | Partially reflective | spherical | Infinity | −7.8692 | 1.762 | 27.58 | Reflection | |
| | element (BS) | | | | | | | |
| 10 | | spherical | −67.3132 | −3.6644 | | | Refraction | |
| 11 | | spherical | −3463.0335 | −2.9865 | 1.620 | 54.07 | Refraction | |
| 12 | | spherical | 40.4165 | −1.7165 | | | Refraction | |
| 13 | | spherical | Infinity | −0.1100 | 1.502 | 57.00 | Refraction | |
| 14 | | spherical | Infinity | −0.1100 | 1.502 | 57.00 | Refraction | |
| 15 | Reflective Polarizing | spherical | Infinity | 0.1100 | 1.502 | 57.00 | Reflection | |
| | Element (RP) | | | | | | | |
| 16 | | spherical | Infinity | 0.1100 | 1.502 | 57.00 | Refraction | |
| 17 | | spherical | Infinity | 1.7165 | | | Refraction | |
| 18 | Second lens (E2) | spherical | 40.4165 | 2.9865 | 1.620 | 54.07 | Refraction | |
| 19 | | spherical | −3463.0335 | 3.6644 | | | Refraction | |
| 20 | Third lens (E3) | spherical | −67.3132 | 7.8692 | 1.762 | 27.58 | Refraction | |
| 21 | Second Quarter-Wave | spherical | Infinity | 0.1000 | 1.502 | 57.00 | Refraction | |
| | Plate (QWP2) | | | | | | | |
| 22 | Polarizer (LP) | spherical | Infinity | 0.1500 | 1.502 | 57.00 | Refraction | |
| 23 | | spherical | Infinity | 0.9207 | | | Refraction | |
| 24 | Fourth lens (E4) | aspherical | −50.0000 | 3.5794 | 1.679 | 19.24 | Refraction | −19.9677 |
| 25 | | aspherical | 36.3199 | 1.3860 | | | Refraction | −24.5494 |
| 26 | Protective glass | spherical | Infinity | 0.7100 | 1.519 | 64.17 | Refraction | |
| 27 | | spherical | Infinity | 0.3000 | | | Refraction | |
| 28 | Image surface (IMG) | spherical | Infinity | 0.0000 | | | Refraction | |

In this embodiment, both the first side surface and the second side surface of the fourth lens E4 are aspherical. The surface profile X of each aspherical lens can be defined by, but is not limited to, the formula (1) given in the foregoing Embodiment 1.

Table 8 shows the high-order coefficients A4, A6, A8, A10, A12, A14, A16, A18, and A20 that can be used for the aspherical lens surfaces S24 and S25 in Embodiment 4.

TABLE 8

Surface number

| Coefficient | S24 | S25 |
|---|---|---|
| A4 | −6.8546E−01 | −2.1570E+00 |
| A6 | 3.7860E−03 | −1.9110E−01 |
| A8 | −8.2873E−03 | 1.0604E−01 |
| A10 | −8.3534E−03 | 2.7833E−01 |
| A12 | −4.9913E−03 | 3.0362E−01 |
| A14 | −3.4235E−03 | 1.9979E−01 |
| A16 | −7.6445E−04 | 8.1092E−02 |
| A18 | −2.7595E−04 | 1.3543E−02 |
| A20 | 0.0000E+00 | 0.0000E+00 |

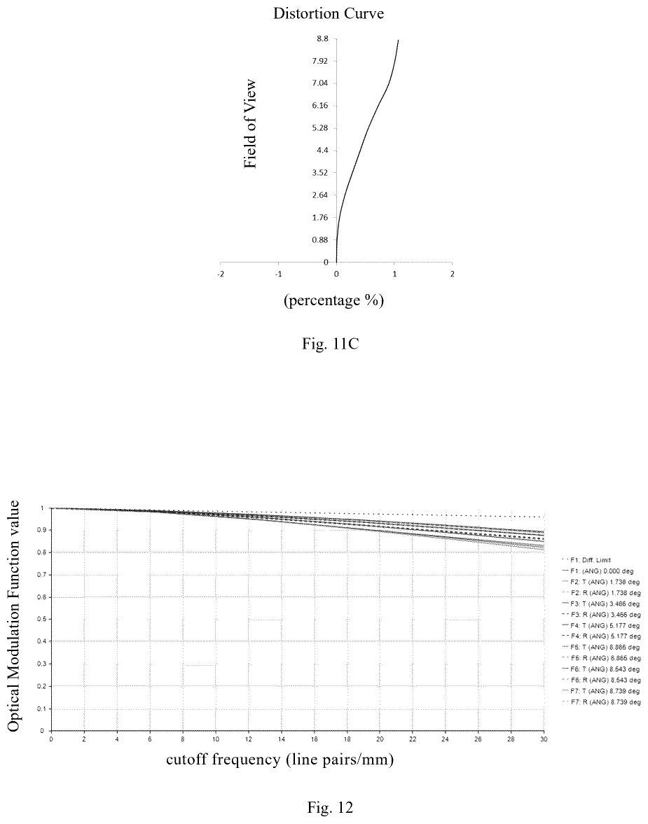

FIG. 11A shows the longitudinal aberration curve of the optical system of Embodiment 4, which represents the deviation of the converging point of light rays of different wavelengths after passing through the optical system. FIG. 11B shows the astigmatism curve of the optical system of Embodiment 4, which represents the curvature of a tangential plane and the curvature of a sagittal plane corresponding to different field angles. FIG. 11C shows the distortion curve of the optical system of Embodiment 4, which represents the distortion magnitude corresponding to different field angles. From FIGS. 11A to 11C, it can be seen that the optical system given in Embodiment 4 can achieve good imaging quality.

FIG. 12 shows the MTF curve of the optical imaging system of Embodiment 4. From FIG. 12, it can be seen that the optical system of this embodiment has good contrast within a spatial frequency of 30 lp/mm, and the imaging is clear.

### Embodiment 5

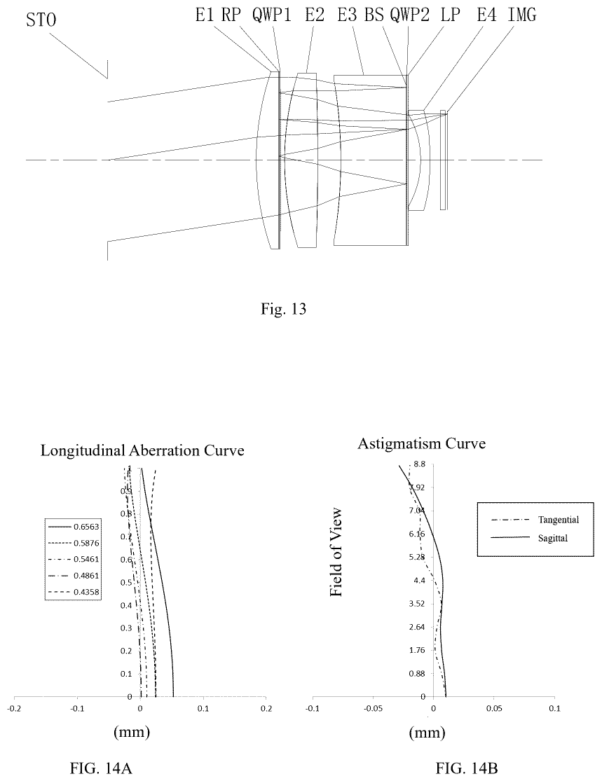

FIG. 13 shows a schematic structural diagram of an optical system according to Embodiment 5 of the present application.

As shown in FIG. 13, the optical system comprises, arranged sequentially along an optical axis from the human eye side to the display side: a first lens E1, a reflective polarizing element RP, a first quarter-wave plate QWP1, a second lens E2, a third lens E3, a partially reflective element BS, a second quarter-wave plate QWP2, a polarizer LP, and a fourth lens E4.

The optical system may further comprise an aperture stop STO arranged on the human eye side. The aperture stop STO may be arranged on the first side of the first lens E1.

In this embodiment, the first lens E1 has positive refractive power. The first side surface of the first lens E1 is a convex surface, and the second side surface is a plane. The reflective polarizing element RP and the first quarter-wave plate QWP1 are sequentially attached to the second side surface. The second lens E2 has positive refractive power. The first side surface is a convex surface, and the second side surface is a convex surface. The third lens E3 has a concave first side surface and a planar second side surface. The partially reflective element BS, the second quarter-wave plate QWP2, and the polarizer LP are sequentially attached to the second side surface. The fourth lens E4 has negative refractive power. The first side surface is a concave surface, and the second side surface is a convex surface.

Table 9 shows the basic parameter table of the optical system of Embodiment 5, wherein the units for radius of curvature and thickness/distance are all millimeters (mm).

TABLE 9

| | | | | | Material | | | |
|---|---|---|---|---|---|---|---|---|
| Surface | | Surface | Radius of | Thickness/ | Refractive | Abbe | Refraction/ | Cone |
| Number | Optical element | Type | Curvature | Distance | Index | number | Reflection | coefficient |
| 0 | | spherical | Infinity | −105000.00 | | | Refraction | |
| 1 | Aperture Stop (STO) | spherical | Infinity | 21.0000 | | | Refraction | |
| 2 | First lens (E1) | spherical | 38.6088 | 3.1696 | 1.507 | 70.49 | Refraction | |
| 3 | Reflective Polarizing | spherical | Infinity | 0.1100 | 1.502 | 57.00 | Refraction | |
| | Element (RP) | | | | | | | |
| 4 | First Quarter-Wave | spherical | Infinity | 0.1100 | 1.502 | 57.00 | Refraction | |
| | Plate (QWP1) | | | | | | | |
| 5 | | spherical | Infinity | 0.6135 | | | Refraction | |
| 6 | Second lens (E2) | spherical | 41.1789 | 4.6701 | 1.610 | 56.82 | Refraction | |
| 7 | | spherical | −373.2251 | 3.2659 | | | Refraction | |
| 8 | Third lens (E3) | spherical | −67.4896 | 9.2676 | 1.723 | 29.52 | Refraction | |
| 9 | Partially reflective | spherical | Infinity | −9.2676 | 1.723 | 29.52 | Reflection | |
| | element (BS) | | | | | | | |
| 10 | | spherical | −67.4896 | −3.2659 | | | Refraction | |
| 11 | | spherical | −373.2251 | −4.6701 | 1.610 | 56.82 | Refraction | |
| 12 | | spherical | 41.1789 | −0.6135 | | | Refraction | |
| 13 | | spherical | Infinity | −0.1100 | 1.502 | 57.00 | Refraction | |
| 14 | | spherical | Infinity | −0.1100 | 1.502 | 57.00 | Refraction | |
| 15 | Reflective Polarizing | spherical | Infinity | 0.1100 | 1.502 | 57.00 | Reflection | |
| | Element (RP) | | | | | | | |
| 16 | | spherical | Infinity | 0.1100 | 1.502 | 57.00 | Refraction | |
| 17 | | spherical | Infinity | 0.6135 | | | Refraction | |
| 18 | Second lens (E2) | spherical | 41.1789 | 4.6701 | 1.610 | 56.82 | Refraction | |
| 19 | | spherical | −373.2251 | 3.2659 | | | Refraction | |
| 20 | Third lens (E3) | spherical | −67.4896 | 9.2676 | 1.723 | 29.52 | Refraction | |
| 21 | Second Quarter-Wave | spherical | Infinity | 0.1000 | 1.502 | 57.00 | Refraction | |
| | Plate (QWP2) | | | | | | | |
| 22 | Polarizer (LP) | spherical | Infinity | 0.1500 | 1.502 | 57.00 | Refraction | |
| 23 | | spherical | Infinity | 1.7566 | | | Refraction | |
| 24 | Fourth lens (E4) | aspherical | −13.6740 | 1.3000 | 1.679 | 19.24 | Refraction | −3.7555 |
| 25 | | aspherical | −45.0000 | 1.4768 | | | Refraction | 36.5401 |
| 26 | Protective glass | spherical | Infinity | 0.7100 | 1.519 | 64.17 | Refraction | |
| 27 | | spherical | Infinity | 0.3000 | | | Refraction | |
| 28 | Image surface (IMG) | spherical | Infinity | 0.0000 | | | Refraction | |

In this embodiment, both the first side surface and the second side surface of the fourth lens E4 are aspherical. The surface profile X of each aspherical lens can be defined by, but is not limited to, the formula (1) given in the foregoing Embodiment 1.

Table 10 shows the high-order coefficients A4, A6, A8, A10, A12, A14, A16, A18, and A20 that can be used for the aspherical lens surfaces S24 and S25 in Embodiment 5.

TABLE 10

Surface number

| Coefficient | S24 | S25 |
|---|---|---|
| A4 | −5.6635E−01 | −1.9809E−01 |
| A6 | 1.4571E−02 | −3.1399E−01 |
| A8 | −1.1511E−02 | −2.4986E−01 |
| A10 | −3.4113E−02 | 1.0909E−01 |
| A12 | −5.4541E−03 | 1.9584E−01 |
| A14 | −1.1154E−02 | −1.7031E−02 |
| A16 | 1.6867E−03 | −7.5399E−02 |
| A18 | −1.1201E−03 | −5.8405E−02 |
| A20 | 0.0000E+00 | 0.0000E+00 |

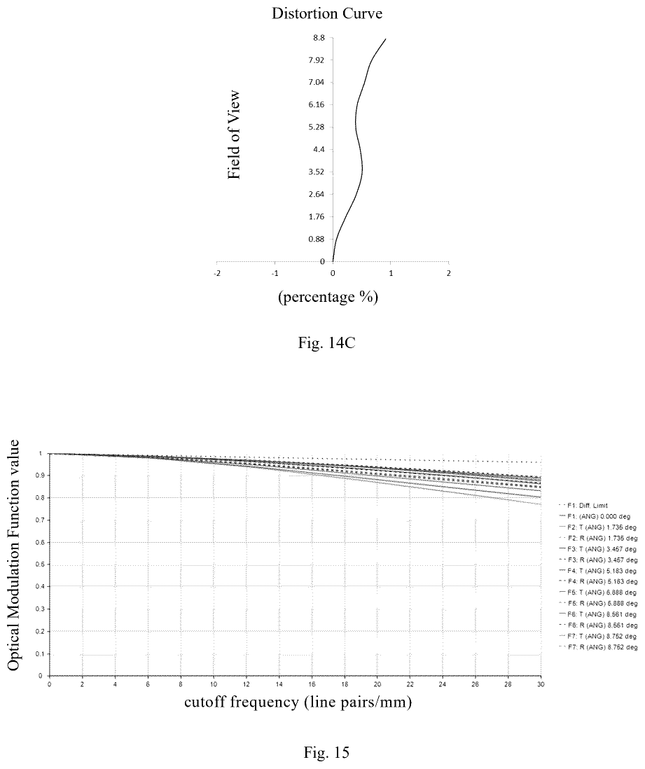

FIG. 14A shows the longitudinal aberration curve of the optical system of Embodiment 5, which represents the deviation of the converging point of light rays of different wavelengths after passing through the optical system. FIG. 14B shows the astigmatism curve of the optical system of Embodiment 5, which represents the curvature of a tangential plane and the curvature of a sagittal plane corresponding to different field angles. FIG. 14C shows the distortion curve of the optical system of Embodiment 5, which represents the distortion magnitude corresponding to different field angles. From FIGS. 14A to 14C, it can be seen that the optical system given in Embodiment 5 can achieve good imaging quality.

FIG. 15 shows the MTF curve of the optical imaging system of Embodiment 5. From FIG. 15, it can be seen that the optical system of this embodiment has good contrast within a spatial frequency of 30 lp/mm, and the imaging is clear.

Table 11 shows the optical parameters of the optical systems of the above Embodiments 1 to 5, such as the entrance pupil diameter EPD of the optical system, the effective focal length f of the optical system, and the effective focal length of each lens, combined focal length, and other related parameters. The unit for each optical parameter is millimeters (mm).

TABLE 11

| | Embodiment | | | | |
|---|---|---|---|---|---|
| Parameter | 1 | 2 | 3 | 4 | 5 |
| f(mm) | 42.00 | 42.00 | 42.00 | 42.00 | 42.00 |
| f1(mm) | 64.76 | 45.35 | 73.87 | 63.58 | 76.19 |
| f2(mm) | 70.44 | 66.90 | 56.51 | 64.47 | 61.07 |
| f3(mm) | −88.59 | −67.79 | −76.17 | −88.38 | −93.33 |
| f4(mm) | −55.05 | −49.84 | −37.66 | −30.48 | −29.43 |
| EPD(mm) | 23.00 | 23.00 | 23.00 | 23.00 | 23.00 |
| TD(mm) | 23.62 | 23.80 | 23.64 | 24.60 | 24.51 |
| FG1(mm) | 64.76 | 45.35 | 73.87 | 63.58 | 76.19 |
| FG2(mm) | −88.59 | −67.79 | −76.17 | −88.38 | −93.33 |
| SAG11(mm) | 1.98 | 2.29 | 2.00 | 2.10 | 1.87 |
| SAG21(mm) | 1.65 | 1.03 | 1.61 | 1.67 | 1.70 |
| SAG41(mm) | 0.43 | 0.0012 | −0.03 | −0.81 | −1.64 |
| SAG42(mm) | 1.08 | 0.90 | 0.84 | 0.11 | −0.72 |

In summary, the optical systems in Embodiments 1 to 5 respectively satisfy the conditional formulas shown in Table 12 below.

TABLE 12

| | Embodiment | | | | |
|---|---|---|---|---|---|
| Conditional Formula | 1 | 2 | 3 | 4 | 5 |
| f3/f1 | −1.37 | −1.49 | −1.03 | −1.39 | −1.23 |
| (CT3 + CTQ2 + CTL)/ | 2 | 2.27 | 2.68 | 2.24 | 2.81 |
| (CT1 + CTR + CTQ1) | | | | | |
| f2/R3 | 1.73 | 1 | 1.33 | 1.6 | 1.48 |
| TD/f | 0.56 | 0.57 | 0.56 | 0.59 | 0.58 |
| f4/f | −1.31 | −1.19 | −0.9 | −0.73 | −0.7 |
| N3/N1 | 1.12 | 1.01 | 1.14 | 1.14 | 1.14 |
| V3/V1 | 0.44 | 0.61 | 0.48 | 0.44 | 0.42 |
| f/(CT1 + CTR + CTQ1) | 11.99 | 11.02 | 11.94 | 11.61 | 12.39 |
| f1/R1 | 1.8 | 1.34 | 2.04 | 1.85 | 1.97 |
| CT3/ΣCT | 0.42 | 0.39 | 0.51 | 0.44 | 0.5 |
| EPD/TD | 0.97 | 0.97 | 0.97 | 0.93 | 0.94 |
| f3/R5 | 1.34 | 1.31 | 1.43 | 1.31 | 1.38 |
| FG1/f2 | 0.92 | 0.68 | 1.31 | 0.99 | 1.25 |
| FG2/f4 | 1.61 | 1.36 | 2.02 | 2.9 | 3.17 |
| SAG21/SAG11 | 0.83 | 0.45 | 0.81 | 0.8 | 0.91 |
| (\|SAG41\| + | 0.48 | 0.44 | 0.6 | 0.26 | 1.82 |
| \|SAG42\|)/CT4 | | | | | |

The above description merely provides preferred embodiments of the present application and an explanation of the technical principles employed. Those skilled in the art should understand that the scope of disclosure involved in the present application is not limited to technical solutions formed by specific combinations of the above technical features, but should also cover other technical solutions formed by any combination of the above technical features or their equivalent features without departing from the inventive concept. For example, technical solutions formed by mutually substituting the above features with technical features having similar functions disclosed in the present application (but not limited to).

What is claimed is:

1. An optical system, sequentially comprising along the optical axis from a first side to a second side:
a first lens with positive refractive power, having a convex first side surface and a planar second side surface;
a reflective polarizing element;
a first quarter-wave plate;
a second lens with positive refractive power, having a convex first side surface;
a third lens with negative refractive power, having a concave first side surface and a planar second side surface;
a partially reflective element;
a second quarter-wave plate;
a polarizer; and
a fourth lens with negative refractive power;
wherein, the number of lenses with refractive power in the optical system is four;
the effective focal length f1 of the first lens and the effective focal length f3 of the third lens satisfy: −1.5<f3/f1<−1.0; and
the center thickness CT3 of the third lens on the optical axis, the center thickness CTL of the polarizer on the optical axis, the center thickness CTQ2 of the second quarter-wave plate on the optical axis, the center thickness CT1 of the first lens on the optical axis, the center thickness CTR of the reflective polarizing element on the optical axis, and the center thickness CTQ1 of the first quarter-wave plate on the optical axis satisfy: 2≤(CT3+CTQ2+CTL)/(CT1+CTR+CTQ1) <2.9.

2. The optical system according to claim 1, wherein the effective focal length f2 of the second lens and the radius of curvature R3 of the first side surface of the second lens satisfy:
$$1 \leq f 2 / R 3 < 1.8 .$$

3. The optical system according to claim 1, wherein the distance TD on the optical axis from the first side surface of the first lens to the second side surface of the fourth lens and the effective focal length f of the optical system satisfy: 0.5<TD/f<0.6.

4. The optical system according to claim 1, wherein the effective focal length f4 of the fourth lens and the effective focal length f of the optical system satisfy: −1.4<f4/f≤−0.7.

5. The optical system according to claim 1, wherein the refractive index N3 of the third lens, the refractive index N1 of the first lens, the Abbe number V3 of the third lens, and the Abbe number V1 of the first lens satisfy: 1.0<N3/N1<1.2; 0.4<V3/V1<0.7.

6. The optical system according to claim 1, wherein the effective focal length f of the optical system, the center thickness CT1 of the first lens on the optical axis, the center thickness CTR of the reflective polarizing element on the optical axis, and the center thickness CTQ1 of the first quarter-wave plate on the optical axis satisfy: 11<f/(CT1+CTR+CTQ1)<12.4.

7. The optical system according to claim 1, wherein the effective focal length f1 of the first lens and the radius of curvature R1 of the first side surface of the first lens satisfy: 1.3<f1/R1<2.1.

8. The optical system according to claim 1, wherein the center thickness CT3 of the third lens on the optical axis, and the sum of the center thicknesses of the first lens to the fourth lens on the optical axis ΣCT satisfy: 0.35<CT3/ΣCT<0.55.

9. The optical system according to claim 1, wherein the entrance pupil diameter EPD of the optical system and the distance TD on the optical axis from the first side surface of the first lens to the second side surface of the fourth lens satisfy: 0.9<EPD/TD<1.0.

10. The optical system according to claim 1, wherein the effective focal length f3 of the third lens and the radius of curvature R5 of the first side surface of the third lens satisfy: 1.3<f3/R5<1.5.

11. The optical system according to claim 1, wherein the combined focal length FG1 of the first lens and the reflective polarizing element and the first quarter-wave plate, and the effective focal length f2 of the second lens satisfy: 0.6<FG1/f2<1.4.

12. The optical system according to claim 1, wherein the combined focal length FG2 of the third lens and the second quarter-wave plate and the polarizer, and the effective focal length f4 of the fourth lens satisfy: 1.3<FG2/f4<3.2.

13. The optical system according to claim 1, wherein the axial distance SAG21 from the intersection of the first side surface of the second lens and the optical axis to the effective radius vertex of the first side surface of the second lens, and the axial distance SAG11 from the intersection of the first side surface of the first lens and the optical axis to the effective radius vertex of the first side surface of the first lens satisfy: 0.4<SAG21/SAG11<1.0.

14. The optical system according to claim 1, wherein the axial distance SAG41 from the intersection of the first side surface of the fourth lens and the optical axis to the effective radius vertex of the first side surface of the fourth lens, the axial distance SAG42 from the intersection of the second side surface of the fourth lens and the optical axis to the effective radius vertex of the second side surface of the fourth lens, and the center thickness CT4 of the fourth lens on the optical axis satisfy: 0.2< (|SAG4|+|SAG42|)/CT4<1.9.

15. The optical system according to claim 1, wherein the reflective polarizing element is arranged on the second side surface of the first lens and is at least partially attached to the second side surface of the first lens; the first quarter-wave plate is arranged on the second side surface of the reflective polarizing element and is at least partially attached to the second side surface of the reflective polarizing element; and
wherein the partially reflective element is arranged on the second side surface of the third lens and is at least partially attached to the second side surface of the third lens; the second quarter-wave plate is arranged on the second side surface of the partially reflective element and is at least partially attached to the second side surface of the partially reflective element; the polarizer is arranged on the second side surface of the second quarter-wave plate and is at least partially attached to the second side surface of the second quarter-wave plate.

16. The optical system according to claim 2, wherein the reflective polarizing element is arranged on the second side surface of the first lens and is at least partially attached to the second side surface of the first lens; the first quarter-wave plate is arranged on the second side surface of the reflective polarizing element and is at least partially attached to the second side surface of the reflective polarizing element; and
wherein the partially reflective element is arranged on the second side surface of the third lens and is at least partially attached to the second side surface of the third lens; the second quarter-wave plate is arranged on the second side surface of the partially reflective element and is at least partially attached to the second side surface of the partially reflective element; the polarizer is arranged on the second side surface of the second quarter-wave plate and is at least partially attached to the second side surface of the second quarter-wave plate.

17. The optical system according to claim 3, wherein the reflective polarizing element is arranged on the second side surface of the first lens and is at least partially attached to the second side surface of the first lens; the first quarter-wave plate is arranged on the second side surface of the reflective polarizing element and is at least partially attached to the second side surface of the reflective polarizing element; and
wherein the partially reflective element is arranged on the second side surface of the third lens and is at least partially attached to the second side surface of the third lens; the second quarter-wave plate is arranged on the second side surface of the partially reflective element and is at least partially attached to the second side surface of the partially reflective element; the polarizer is arranged on the second side surface of the second quarter-wave plate and is at least partially attached to the second side surface of the second quarter-wave plate.

18. The optical system according to claim 4, wherein the reflective polarizing element is arranged on the second side surface of the first lens and is at least partially attached to the second side surface of the first lens; the first quarter-wave plate is arranged on the second side surface of the reflective polarizing element and is at least partially attached to the second side surface of the reflective polarizing element; and
wherein the partially reflective element is arranged on the second side surface of the third lens and is at least partially attached to the second side surface of the third lens; the second quarter-wave plate is arranged on the second side surface of the partially reflective element and is at least partially attached to the second side surface of the partially reflective element; the polarizer is arranged on the second side surface of the second quarter-wave plate and is at least partially attached to the second side surface of the second quarter-wave plate.

19. The optical system according to claim 5, wherein the reflective polarizing element is arranged on the second side surface of the first lens and is at least partially attached to the second side surface of the first lens; the first quarter-wave plate is arranged on the second side surface of the reflective polarizing element and is at least partially attached to the second side surface of the reflective polarizing element; and
wherein the partially reflective element is arranged on the second side surface of the third lens and is at least partially attached to the second side surface of the third lens; the second quarter-wave plate is arranged on the second side surface of the partially reflective element and is at least partially attached to the second side surface of the partially reflective element; the polarizer is arranged on the second side surface of the second quarter-wave plate and is at least partially attached to the second side surface of the second quarter-wave plate.

20. The optical system according to claim 6, wherein the reflective polarizing element is arranged on the second side surface of the first lens and is at least partially attached to the second side surface of the first lens; the first quarter-wave plate is arranged on the second side surface of the reflective polarizing element and is at least partially attached to the second side surface of the reflective polarizing element; and
wherein the partially reflective element is arranged on the second side surface of the third lens and is at least partially attached to the second side surface of the third lens; the second quarter-wave plate is arranged on the second side surface of the partially reflective element and is at least partially attached to the second side surface of the partially reflective element; the polarizer is arranged on the second side surface of the second quarter-wave plate and is at least partially attached to the second side surface of the second quarter-wave plate.
